(19) United States
(12) Patent Application Publication
(10) Pub. No.: US 2015/0293585 A1
(43) Pub. Date: Oct. 15, 2015

(54) SYSTEM AND METHOD FOR CONTROLLING HEADS UP DISPLAY FOR VEHICLE

(71) Applicant: Hyundai Motor Company, Seoul (KR)

(72) Inventors: Dong Hee Seok, Seoul (KR); Seok Beom Lee, Seoul (KR); Yang Shin Kim, Tongyeong (KR)

(21) Appl. No.: 14/484,875

(22) Filed: Sep. 12, 2014

(30) Foreign Application Priority Data
Apr. 9, 2014 (KR) 10-2014-0042528

(51) Int. Cl. G06F 3/00; G06F 3/0482; G06F 3/0481; G06F 3/01

(52) U.S. Cl. CPC G06F 3/005; G06F 3/013; G06F 3/017; G06F 3/0482; G06F 3/04817

(57) ABSTRACT

A technique for controlling a heads up display for a vehicle capable of directly controlling contents using gaze information received from a camera for gaze tracking and coordinates of a recognizable specific object such as a hand. The technique for controlling a head up display for a vehicle includes: tracking a driver's gaze using a camera; when the gaze stares at the HUD, detecting a gaze vector based on the gaze tracking; detecting the gaze vector and then detecting a hand between the camera and the driver's gaze and tracking coordinates of a tip of the hand; matching a final coordinate of the driver's gaze staring at the HUD and a final coordinate of the tip of the hand; and controlling the HUD using the driver's hand.

### CROSS-REFERENCE TO RELATED APPLICATION

This application is based on and claims the benefit of priority to Korean Patent Application No. 10-2014-0042528, filed on Apr. 9, 2014 in the Korean Intellectual Property Office, the disclosure of which is incorporated herein in its entirety by reference.

### TECHNICAL FIELD

The present disclosure relates to a method for controlling a heads up display (HUD) for a vehicle, and more particularly, to a technology of directly controlling contents of a heads up display of a vehicle.

### BACKGROUND

Among various systems which are being developed as a medium of securing driver's safety and effectively transferring vehicle driving information and surrounding conditional information to a driver, a heads up display (hereinafter, referred to as ‘HUD’) has been of primary interest for most vehicle manufactures.

A HUD is any transparent display that presents data without requiring users to look away from their usual viewpoints (i.e., the line of sight to the road in the vehicle. In its initial stage, the HUD was developed to provide flight information to a pilot while an airplane during flight in particular, fighting planes. Since then HUDs have been adapted for use in land vehicles allow the vehicle driver to obtain information without having to take his or her eyes off of the road.

As one can imagine, today's vehicles travel at much higher speeds, thus for the safety of others on the road it is imperative that the driver maintain eye contact with the road.

The HUD for a vehicle displays information such as speed, driving distance, RPM, and the like that is usually located only on a dashboard within a driver's main visual field line in a front window so that a driver may easily check the driving information while driving without having to look down. Therefore, the driver recognizes the important driving information without takes his/her eyes off a road thus increasing the overall driving safety of the vehicle.

### SUMMARY

The present disclosure has been made to solve the above-mentioned problems occurring in the prior art while advantages achieved by the prior art remain intact. An aspect of the present disclosure provides a system and method for controlling a head up display for a vehicle capable of directly controlling contents of the head up display for a vehicle using gaze information received from a gaze tracking camera and coordinates of a recognizable specific object such as a hand.

According to an exemplary embodiment of the present disclosure, a system and method for controlling a head up display for a vehicle includes: tracking a driver's gaze using an imaging device such as a camera. When the eyes of the driver are staring at the HUD, a gaze vector is then detected, by a processor, based on the gaze tracking. Next, a hand between the camera and the driver's gaze is detected and tracking coordinates of a tip of the hand (e.g., the driver's fingers) are obtained. Then a final coordinate of the driver's gaze staring at the HUD and a final coordinate of the tip of the hand are matched and the HUD is controlled using the driver's hand as a control means.

In particular, the HUD may be controlled by pushing, clicking, and moving the coordinates with the tip of the hand. More specifically, when the tip of the hand is not photographed by the camera, the control of the HUD may be ended. After the control of the HUD ends, the HUD may be again controlled by tracking the driver's eyes. A menu or an icon within the HUD may be clicked or move with the tip of the driver's hand to operate an application program.

### BRIEF DESCRIPTION OF THE DRAWINGS

The above and other objects, features and advantages of the present disclosure will be more apparent from the following detailed description taken in conjunction with the accompanying drawings.

FIG. 1 is a flow chart illustrating a method for controlling a head up display for a vehicle according to an exemplary embodiment of the present disclosure; and

FIG. 2 is a diagram for describing a method for directly controlling contents of the head up display for a vehicle according to the exemplary embodiment of the present disclosure.

### DETAILED DESCRIPTION

The foregoing objects, features and advantages will become more apparent from the following description of exemplary embodiments of the present disclosure with reference to accompanying drawings, which are set forth hereinafter. Accordingly, those having ordinary knowledge in the related art to which the present disclosure pertains will easily embody technical ideas or spirit of the present disclosure. Further, when technical configurations known in the related art are considered to make the contents obscure in the present disclosure, the detailed description thereof will be omitted. Hereinafter, exemplary embodiments of the present disclosure will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

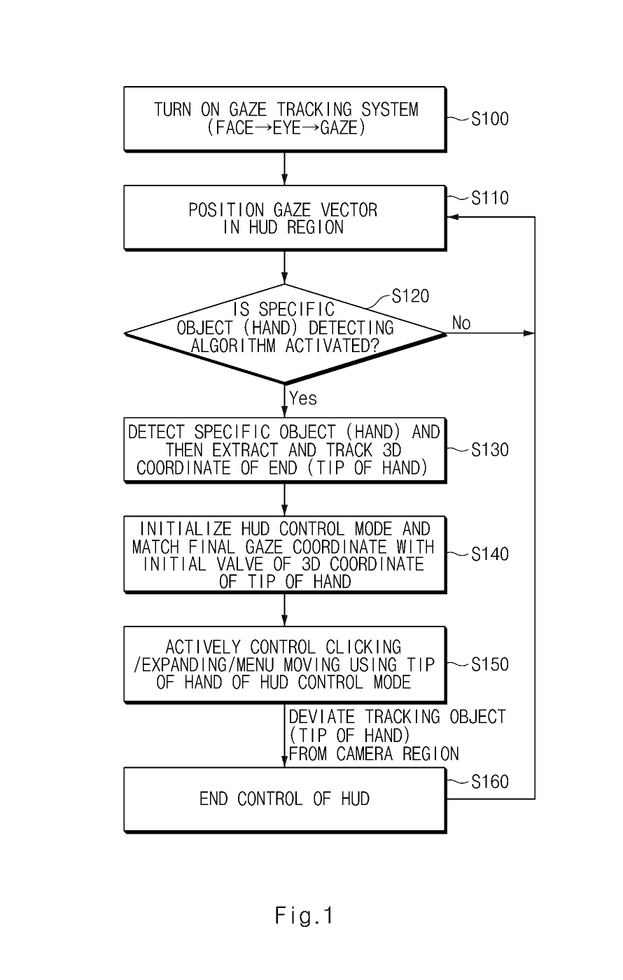

FIG. 1 is a flow chart illustrating a method for controlling a head up display for a vehicle according to an exemplary embodiment of the present disclosure. A gaze tracking camera equipped in a vehicle photographs a driver's face and eyes and then photographs his/her gaze (i.e., line of sight).

In detail, when detecting the driver's face, the gaze tracking camera continuously tracks eyes of the driver's face and when normally detecting driver's eyes, the gaze tracking camera tracks the gaze indicating at the driver's line of sight (S100). The gaze tracking camera sequentially photographs a face, an eye, and a gaze to store gaze information and continuously update the gaze information.

Next, the gaze tracking camera continuously tracks the driver's gaze photographed by the camera and then captures the instant that the driver's gaze stares at the HUD. The gaze tracking camera may obtain a gaze vector from the instant that the driver's gaze is directed toward the HUD to the instant that the driver's gaze is directed away from the HUD (S110).

That is, the gaze vector may be obtained using an angle between the driver's gaze and the HUD, a distance between the gaze tracking camera and the driver, and a distance between the driver and the HUD. A method for obtaining a gaze vector may be implemented based on a gaze tracking algorithm, in which the gaze tracking algorithm is an application program which may detect a pupil central point and a cornea central point in the driver's eye and obtain the gaze vector by connecting the respective two central points. The gaze tracking algorithm is a technology which may sufficiently understood by those skilled in the art and therefore the detailed description thereof will be omitted herein.

The HUD is a technology of projecting a transparent reflected image onto a windshield in a vehicle to allow light transmitted to the windshield to form an image and display the desired information to a driver. This technology may attach a special polarizing film to a transmission region of the windshield to display the image to the driver. In detail, the HUD controls a light emitting unit, a display device, an optical system, and a combiner to be able to form a virtual image in front of the driver and provide image information.

In the exemplary embodiments of the present invention, the driver's gaze stares at the HUD and then a specific object (hand) detecting algorithm is activated (S120). That is, the gaze tracking camera may use the specific object to control the HUD while recognizing the instant at which the driver's gaze stares at the HUD. The specific object representatively describes a hand, but may use any one of a plurality of body parts. In the exemplary embodiment of the present invention, the specific object detecting algorithm is a predefined algorithm, and when the gaze tracking camera does not normally detect the gaze, the specific object detecting algorithm may be activated. As such, after a hand between the gaze tracking camera and the driver's face is detected, coordinates of a tip (finger) of a hand are tracked by the gaze tracking camera (S130).

The coordinates of the tip of the hand may be a 2D or 3D coordinate and a position of the coordinates of the tip of the hand is changed depending on a movement of the hand and the gaze tracking camera may continuously store the coordinates of the tip of the hand of which the position is changed. The coordinates of the tip of the hand may store a first coordinate first photographed by the gaze tracking camera and a final coordinate immediately before the driver's hand deviates between the gaze tracking camera and the driver's face.

Next it is determined if the final coordinate of the driver's gaze staring at the HUD matches the first coordinate of the tip of the hand (5140). Since the position of the driver's gaze may change in the HUD, the position of the driver's gaze is also continuously stored.

Next, after the final coordinate of the driver's gaze staring at the HUD matches the first coordinate of the tip of the hand, the HUD may be continuously controlled using the tip of the hand (S150). That is, the driver may control the HUD by controlling the matched coordinates using a virtual mouse.

Herein, the system and method for controlling a HUD using the tip of the hand may be executed by virtually pushing, moving, or weakly clicking the tip of the hand against the virtual menu of the HUD. Additionally, the system may also be configured to control expansion or reduction of a menu or an icon of the HUD.

For example, in a menu structure of the HUD, after the menu is installed at an edge or on an outside of the HUD by improving a user interface (UI), the driver may click or push the menu using the tip of the hand to operate an application program virtually. Further, even in the case of intending to change the screen configuration such as a speedometer position, a navigation configuration position, and the like in the HUD, the driver may change the position of the screen configuration using the tip of the hand.

Next, when the hand deviates from a photographing region of the gaze tracking camera (i.e., the hand is no longer present in a subsequent photograph), the control of the HUD ends (S160). However, in the case of intending to control the HUD again, the driver stares at the HUD again to gaze-track the HUD using the gaze tracking camera and may again control the HUD using the tip of the hand.

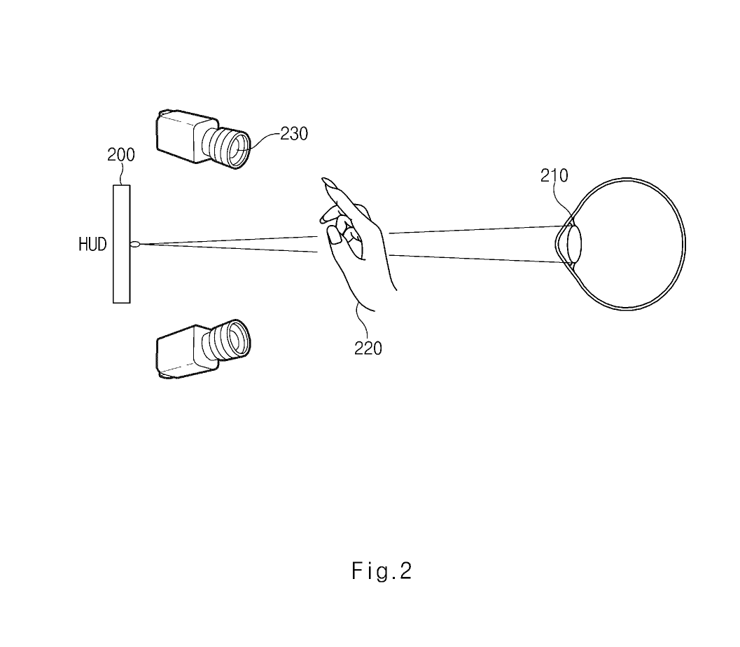

FIG. 2 is a diagram for describing a method for directly controlling contents of the head up display for a vehicle according to the exemplary embodiment of the present disclosure. The method for directly controlling contents of a HUD 200 means that the HUD 200 is directly controlled using a hand 220 between the HUD 200 and a driver's gaze 210. That is, after the gaze tracking camera 230 matches coordinates of the driver's gaze 210 and coordinates of the tip of the hand 220, the driver uses his/her hand 220 to virtually click, push, move the matched coordinates or expand or reduce the menu or the icon so as to directly control the HUD 200.

In more detail, the application program of the HUD 200 may be operated by of matching the final coordinate of the driver's gaze 210 which is photographed by the gaze tracking camera 230 and stares at the HUD 200 with the coordinates of the tip of the hand 220 or virtually pushing, moving, or clicking the matched coordinates using the tip of the hand 220. In addition, the screen configuration of the HUD 200 may also be changed and the position of the speedometer display, the navigation position, and the like including the information inside the vehicle may be changed.

Herein, the HUD 200 described herein is understood to be a technology which projects a reflected image to a windshield in a vehicle to allow light transmitted to the windshield to form an image and display the desired information to a driver, in which the technology may attach a special polarizing film to a transmission region of the windshield to display the image to the driver.

In detail, the head up display 200 for a vehicle controls a light emitting unit, a display device, an optical system, and a combiner to form a virtual image in front of the driver and provide image information.

As described above, the present technology may directly control the contents of the head up display for a vehicle to allow the driver to use the real-time information. Further, the present technology may freely change the screen configuration of the head up display for a vehicle and allow the driver to easily change the desired information and position.

According to the exemplary embodiments of the present disclosure, the driver may use the real-time information by directly controlling the contents of the head up display for a vehicle.

Further, according to the exemplary embodiment of the present disclosure, the driver may freely change the screen configuration of the head up display for a vehicle, directly select his/her desired information, and easily change the position of the head up display for a vehicle.

Hereinabove, although exemplary embodiments of the present disclosure are illustrated and described, the present disclosure is not limited to the aforementioned exemplary embodiment and it is apparent that various modifications can be made to those skilled in the art without departing from the spirit of the present disclosure described in the appended claims and the modified embodiments are not to be individually understood from the technical spirit and prospects of the present disclosure.

What is claimed is:

1. A method for controlling a head up display for a vehicle, comprising:
tracking, by an imaging device a driver's gaze;
in response to the driver's gaze being directed toward a heads up display (HUD), determining a gaze vector based on the gaze tracking;
in response to determining the gaze vector, detecting a hand between the imaging device and the driver's gaze and tracking coordinates of a tip of the hand;
matching a final coordinate of the driver's gaze staring at the HUD and a final coordinate of the tip of the hand; and
controlling the HUD using the hand.

2. The method of claim 1, wherein in the controlling of the HUD using the hand, the HUD is controlled by virtually pushing, clicking, and moving the coordinates with the tip of the hand.

3. The method of claim 1, wherein in the controlling of the HUD using the hand, when the tip of the hand is no longer present in a subsequent image photographed by the imaging device, the control of the HUD ends.

4. The method of claim 3, wherein after the control of the HUD ends, the driver's gaze is again tracked.

5. The method of claim 1, wherein a menu or an icon within the HUD is virtually clicked or moved with the tip of the hand to operate an application program.

6. A system for controlling a head up display for a vehicle, comprising:
an imaging device configured to track a driver's gaze;
a processor configured to, in response to the driver's gaze being directed toward a heads up display (HUD), determine a gaze vector based on the gaze tracking, detect a hand between the imaging device and the driver's gaze in response to determining the gaze vector and track coordinates of a tip of the hand, match a final coordinate of the driver's gaze staring at the HUD and a final coordinate of the tip of the hand, and control the HUD based on actions of the hand.

7. The system of claim 6, wherein the HUD is controlled by virtually pushing, clicking, and moving the coordinates with the tip of the hand.

8. The system of claim 6, wherein when the tip of the hand is no longer present in a subsequent image photographed by the imaging device, the control of the HUD ends.

9. The system of claim 8, wherein after the control of the HUD ends, the driver's gaze is again tracked.

10. The system of claim 6, wherein a menu or an icon within the HUD is virtually clicked or moved with the tip of the hand to operate an application program.

11. A non-transitory computer readable medium containing program instructions executed by a processor or controller, the computer readable medium comprising:
program instructions that track a driver's gaze;
program instructions that in response to the driver's gaze being directed toward a heads up display (HUD),
program instructions that determine a gaze vector based on the gaze tracking,
program instructions that detect a hand between the imaging device and the driver's gaze in response to determining the gaze vector and track coordinates of a tip of the hand,
program instructions that match a final coordinate of the driver's gaze staring at the HUD and a final coordinate of the tip of the hand, and
program instructions that control the HUD based on actions of the hand.

12. The non-transitory computer readable medium of claim 11, wherein the HUD is controlled by virtually pushing, clicking, and moving the coordinates with the tip of the hand.

13. The non-transitory computer readable medium of claim 11, wherein when the tip of the hand is no longer present in a subsequent image photographed by the imaging device, the control of the HUD ends.

14. The non-transitory computer readable medium of claim 13, wherein after the control of the HUD ends, the driver's gaze is again tracked.

15. The non-transitory computer readable medium of claim 11, wherein a menu or an icon within the HUD is virtually clicked or moved with the tip of the hand to operate an application program.
